(19) United States
(12) Patent Application Publication
(10) Pub. No.: US 2013/0185454 A1
(43) Pub. Date: Jul. 18, 2013

(54) TECHNIQUE FOR OBTAINING, VIA A FIRST NODE, INFORMATION RELATING TO PATH CONGESTION

(71) Applicants: Fabrice Guillemin, Pleumeur-Bodou (FR); Isabelle Hamchaoui, Tregastel (FR); Thierry Le Maguer, Lannion (FR)

(72) Inventors: Fabrice Guillemin, Pleumeur-Bodou (FR); Isabelle Hamchaoui, Tregastel (FR); Thierry Le Maguer, Lannion (FR)

(73) Assignee: France Telecom, Paris (FR)

(21) Appl. No.: 13/824,735

(22) PCT Filed: Sep. 29, 2011
(86) PCT No.: PCT/FR2011/052273

§ 371 Date: Mar. 18, 2013

(30) Foreign Application Priority Data
Sep. 30, 2010 (FR) 1057887

(51) Int. Cl. H04L 12/56

(52) U.S. Cl. CPC H04L 47/122
USPC 709/235

(57) ABSTRACT

A method for obtaining, by a first node, information relating to a congestion on a path allowing the routing of packets from said first node destined for a second node in a packet communications network, said congestion potentially degrading said routing.

The invention relates to a technique for obtaining, by a first node, information relating to a congestion on a path between this first node and a second node. More particularly, this path allows the routing of packets from the first node to the second node.

The invention is situated in the field of telecommunications and, more particularly, in the field of the detection of congestion in networks using communication by packets.

The application of the invention is particularly advantageous for session admission control in such packet communications networks.

A congestion is able to occur in any equipment situated on the path taken by a packet. More particularly, a unit of equipment can be congested in the input or output memories, in internal queues, etc.

Congestion notification functions have been defined by standards bodies for packet communications networks. These functions are based on various mechanisms, amongst which the following may be mentioned: an Explicit Congestion Notification mechanism, or ECN, a Forward Explicit Congestion Notification mechanism FECN, a Backward Explicit Congestion Notification mechanism BECN or else combinations of these various mechanisms. The term “forward” corresponds to the direction of transmission of a packet, in other words toward the receiver of the packet, and the term “backward” corresponds to the opposite direction to the transmission of the packet, in other words toward the sender of the packet. These various mechanisms use a field in the header of the data packets to carry information relating to the congestion of one of the nodes transporting the packet. Thus, this information relating to the congestion is transmitted in the transfer plane of the data. For example, for a communications network of the IP (Internet Protocol) type, the document from the IETF (Internet Engineering Task Force) RFC 3168 specifies the manner in which an IP packet carries a forward explicit congestion notification ECN. In the following, such an IP packet is referred to as a marked packet.

For the routing protocol TCP (Transmission Control Protocol), based on the IP protocol, for a TCP session established between a transmitter node and a receiver node, the receiver node must notify the transmitter node of a TCP segment of the occurrence of a congestion when it sends back an acknowledgement. The transmitter node can then modify certain parameters of the TCP protocol in order to try to resolve the congestion situation. No information relating to the location of the congestion is available in this case.

Again for this TCP routing protocol, studies have been undertaken for a backward congestion notification. By way of example, the document from the IETF draft-salim-jhsbnns-ecn-00 of June 1998 proposes the use of control plane messages in order to notify the occurrence of a backward congestion. More particularly, the control message “Source Quench” of the ICMP protocol, for “Internet Control Message Protocol”, defined by the document RFC 792, is used to notify the sender of the packet. Such a message notably allows a node routing a packet to implicitly notify the sender of the packet that the latter has been cancelled or else marked by the router. The message notably comprises a part of the cancelled packet. Various optimizations have been proposed, for example in the article “Congestion Control in TCP/IP networks: a combined ECN and BECN approach” by F. Akujobi et al, published in the proceedings of the conference MILCOM 2003, in order to limit the transmission of these ICMP “Source Quench” messages.

However, these solutions have the drawback of requiring a significant interaction between the control and transfer planes since the control plane must obtain from the transfer plane the cancelled or marked packet. For this reason, the notification by means of these messages requires processor and memory resources in the notifying node. These solutions also have the drawback of involve a loading of the backward link, in other words of the node sending a “Source Quench” ICMP message to the node transmitter of the packet, this loading being linked to the transmission of these messages. Moreover, these messages could potentially not reach the transmitter node and the latter is not able to detect a loss of one of these messages. The transmitter node also receives too much information, which it is not able to use owing to the sending of a message for each cancelled or marked packet. Moreover, these methods are only applicable for a TCP session established.

One of the aims of the invention is to overcome these insufficiencies/drawbacks of the prior art and/or to provide improvements for them.

According to a first aspect, one subject of the invention is a method for obtaining, by a first node, information relating to a congestion in a path allowing the routing of packets from said first node to a second node in a packet communications network, said congestion potentially degrading said routing, said method for obtaining information comprising the following steps implemented by the second node:

a step for receiving a first packet originating from the first node and destined for the second node, routed via at least a third node;

a step for processing said first packet in a control plane in which the first and second nodes exchange control messages, following which transmission of a control message to the first node is requested;

a step for obtaining said information from the first packet received;

a step for sending a second packet to the first node, said second packet carrying said control message and comprising said information obtained.

This first packet is designed to trigger the transmission of the control message in the control plane.

In a known manner, the control plane allows the various nodes to exchange control information between them. The transfer plane is in charge of the routing of the packets between the nodes.

A path allows packets to be routed from a first node to a second node, also referred to as receiving node; this path passes through one or more intermediate nodes. The congestion is likely to affect various resources of these intermediate nodes: it may be a congestion affecting a queue in the second node, a congestion affecting hardware resources of the second node, etc. The path is then also congested.

The information relating to a congestion in the downstream direction, in other words in the direction of transmission of the packets, is determined in the transfer plane by one of the congested intermediate nodes and is intended to mark the packets in this direction of transmission, once routed by the congested intermediate node. According to the invention, the information relating to a congestion on the path, received in a first packet, is copied into a second packet, carrying a control message, transmitted in response to the first packet. This second packet is transmitted to the first node in response to the first packet. Thus, this information relating to a congestion of the path is only supplied upon solicitation from the first node and is transmitted backward, in other words in the direction opposite to the direction of transmission of the first packet. The loading generated by the implementation of the method according to the invention is reduced both in the hardware resources and in the processor of the second node and in the links taken to arrive at the first router.

It is underlined here that the first packet is a packet which is destined for the second node and which requires the sending of a control message in reply to the first node.

The information relating to a congestion of the path corresponds for example to the value taken by the bit CE in the ECN information field of the header of a packet, such as specified in the document from the IETF RFC 3168. A value of “1” allows a congestion to be indicated.

Only a very limited modification of the operation in the control and/or transfer planes is required, namely the copying of the congestion information into the response packet. The interaction between the control and transfer planes is also unmodified. Thus, in the case of persistence of the congestion, the notification is made only once whereas in the solutions of the prior art, a large number of packets is likely to be transmitted from the transfer plane to the control plane in order to generate ICMP “Source Quench” control messages.

The congestion notifications are not generated spontaneously, in other words in the absence of solicitation, and it is thus possible for the first node to detect the absence of a response to the sending of the first packet. The first node can then re-transmit the first packet to the second node. The congestion notifications are furthermore transmitted out-of-band, in other words they do not require the establishment of a TCP session.

This allows small fluctuations in traffic to be detected and congestions in the network, even nascent ones, to be localized. The path between the first and second nodes may be divided up into a plurality of segments, some of which correspond, for example, to the connection between two sub-networks, in order to find out the state of congestion of each of the segments. In contrast, the information supplied in the TCP acknowledgement messages is global information on the path taken and it does not allow the elements of the network or segments of the path responsible for the congestion to be localized accurately.

The method for obtaining information furthermore offers an alternative to the detection of congestion by means of SNMP, for “Simple Network Management Protocol”, procedures. These procedures take into account variations in traffic over longer periods of time by the updating and the export by the nodes of values of traffic counters at central collectors according to the SNMP protocol. The reaction time needed according to these procedures is longer.

Thanks to the method for obtaining information, it is thus possible for a network operator to know the level of congestion within certain elements of the network or segments by interrogation. This allows sessions in progress to be protected or modified. This protection may be achieved by the implementation of procedures for admission control of new sessions or else for data-rate modulation. In the case of data-rate modulation, coding techniques which are said to be “scalable”, or SVCs for Scalable Video Coding techniques, may for example be used. An increase in data rate is then possible when the loading conditions of the network allow it, for example an increase in the available rate or the absence of congestion.

According to one particular feature, the first and second nodes implementing a differentiated routing of the packets depending on classes of service, the first packet received comprises information relating to a given class of service and said information obtained is related to congestion affecting at least said class of service.

It is then possible to obtain information relating to a congestion in the path for the routing of packets marked as belonging to the given class of service.

The network operator can then take measures aimed at protecting the sessions corresponding to certain classes of service.

In one variant, the intermediate node is able to indicate a congestion for all the classes of service of a higher level than the given class of service. This allows the information relating to the congestion of a group of classes of service to be obtained in a single request.

According to another particular feature, the control message sent corresponds to a message in reply to another control message received in the first packet.

It is possible to provide a new control message in a protocol of the control plane, this new message requesting the sending of another control message in reply.

This other control message is an echo request transmitted from the first node to the second node.

Such another control message is for example the message “Echo Request” with which the message “Echo Reply” is associated for the ICMP protocol.

According to yet another particular feature, the header of the first packet indicates that a lifetime of said first packet has expired.

It is again possible to obtain the information relating to a congestion on a path by means of the utility program known by the name “Traceroute”, which allows the path taken by a data packet to be determined In this case, the expected response to such a packet corresponds to an error control message. For the ICMP protocol, this may for example be the message “Time Exceeded”.

According to yet another particular feature, the second packet being transmitted to the first node via at least a fourth node, this fourth node does not modify the header of the second packet.

It is underlined here that the paths between two nodes respectively in the backward direction and in the forward direction are not necessarily identical.

When a congestion is able to occur also in the backward direction, in other words from the second node to the first node, the intermediate nodes must not modify the header of the second packet in the transfer plane. It thus suffices to modify the operation of the intermediate nodes in the transfer plane for the control messages used in the implementation of the method for obtaining information. The operation of the nodes in the control plane is not modified.

According to a second aspect, the invention relates to a node in a packet communications network, configured for exchanging with another node control information in a control plane, comprising:

reception means, configured for receiving a first packet originating from the other node;

means for processing said first packet in the control plane, configured for requesting the transmission of a control message destined for the other node following the processing of the first packet;

means for obtaining information from the first packet relating to a congestion in a path allowing the routing of packets from the other node and destined for said node;

transmission means (106), configured for sending a second packet to said other node, said second packet carrying said control message and comprising said information obtained.

According to a third aspect, the invention relates to a communications system in a packet communications network, in which first and second nodes exchange control information in a control plane, said system comprising:

said first node, comprising transmission means configured for sending a first packet, for which the second node must send a control message in reply;

said second node being configured such as previously described.

It is recalled here that the first packet is intended to trigger the generation of a control message in the control plane.

According to a fourth aspect, the invention also relates to a computer program comprising instructions for the implementation of the method for obtaining information according to the first aspect, implemented by a node of a packet communications network, when this program is executed by a processor.

The invention will be better understood with the aid of the following description of particular embodiments of the method of the invention, with reference to the appended drawings in which:

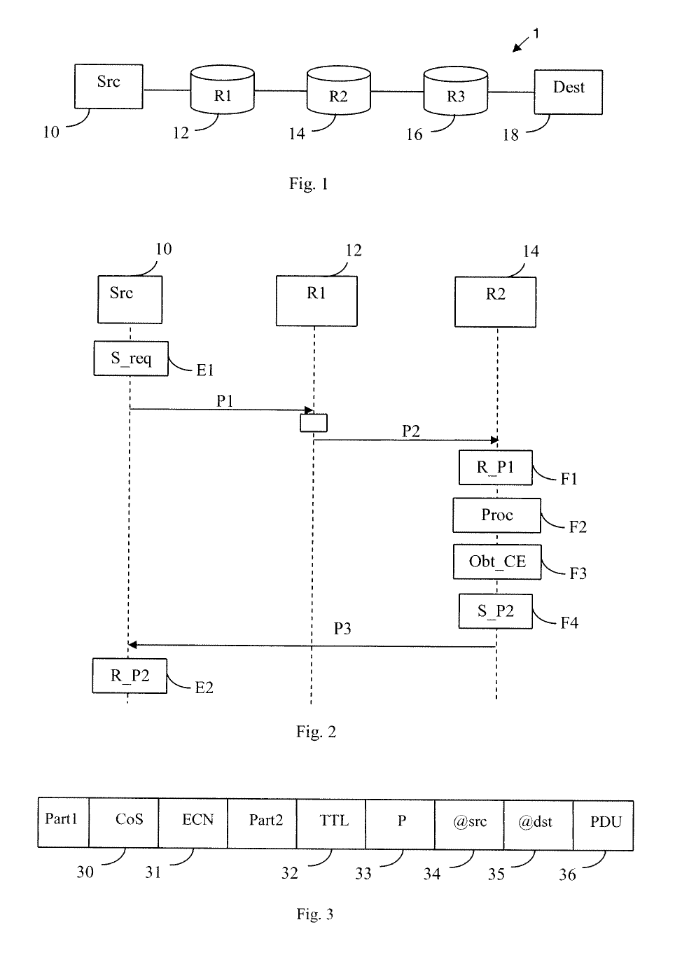

FIG. 1 shows in a simplified manner a packet communications network according to one particular embodiment of the invention;

FIG. 2 shows a simplified diagram of the steps of the method for obtaining information and a schematic of the exchanges between the various entities implementing the method for obtaining information according to one particular embodiment of the invention;

FIG. 3 recalls the structure of a packet in a simplified manner;

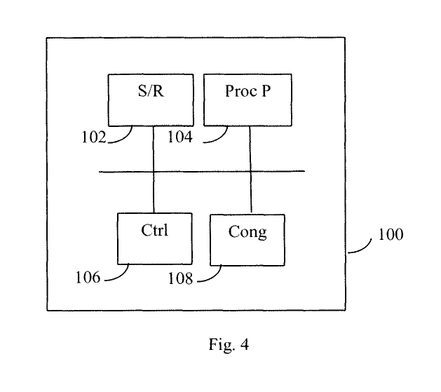

FIG. 4 shows a node according to one particular embodiment of the invention.

In FIG. 1, a packet communications network 1 is shown in a simplified manner. This network 1 comprises a plurality of node units of equipment, five of which 10, 12, 14, 16, 18 are shown in FIG. 1. In the following, these node units of equipment are simply referred to as nodes. These nodes play the role of routers in the network 1, in other words they are in charge of routing packets within a plane, known as transfer plane. A path, also referred to as route, allows packets to be transported from a first node to a second node potentially via other nodes. In another plane, known as control plane, the nodes exchange control information between them, for example by means of the ICMP protocol. It will be clearly understood that the connectivity of a node is not limited to the simplified network such as represented in FIGS. 1 and 2. A node is effectively capable of routing packets toward a plurality of other nodes.

Henceforth, information which indicates the existence of a congestion for at least one of the intermediate nodes on the path is called information relating to a congestion on a path. This congestion is likely to degrade routing of the packets along this path in the transfer plane. When this congestion occurs at a node on the path, for example in a queue intended for storing the packets in memory at the output of the node before re-transmitting them to the next node on the path, the packets are marked by the node prior to re-transmission by means of an ECN, for “Explicit Congestion Notification”, information field. This information field comprises an information sub-field CE for “Congestion Experienced”. The packets are thus marked by positioning the CE information sub-field at the value one. By way of illustrative example, when the node 14 is congested for the routing of the packets received originating from the node 12 and destined for the node 18, via the node 16, these packets are marked at the output of the node 14 and arrive thus marked at the node 18.

According to the invention, when a receiver node has to transmit a control message following the reception of a first packet originating from a requesting node, the receiver node obtains the information relating to the congestion from the first packet received and transmits the control message in a second packet, into which it copies this information. This thus allows the requesting node to receive information relating to the congestion of the path in the forward direction, in other words from the requesting node in the direction of the receiver node. Thus, the requesting node is capable of determining that at least one intermediate node, on a path taken by the packets toward the receiver node, is congested.

A mechanism for notification of a congestion provided in the transfer plane for a first direction of communication is thus used in order to obtain information relating to a congestion on the path and this information is fed back in a second direction of communication opposite to the first direction. This feedback is only applied for certain particular first packets that will trigger the transmission of given control messages. These first packets are detailed later with reference to FIG. 2.

In the following, the case where the nodes 10, 12 and 14 implement the method for obtaining information according to one particular embodiment is considered. More particularly, information relating to a congestion of the path from the node 10 to the node 14 is needed by the node 10.

FIG. 2 shows schematically the steps of the method for obtaining information in this particular embodiment.

In a step E1, the node 10 transmits a first packet P1 to the node 14. FIG. 3 recalls, in the context of the present description, the elements constituting the packets routed within the packet communications network 1. The header of the packet is composed of a set of information fields Part1 to @dst.

In order not to overload the description, the information fields consolidated in the forms Part1, Part2 are not detailed further here, given that they are not involved in the implementation of the method for obtaining information.

The information field CoS 30 comprises information relating to a class of service, when the communications network 1 implements a differentiated routing of the packets depending on classes of service.

The information field 31 corresponds to the ECN information field previously described.

The information field 32 TTL, for “Time-To-Live”, indicates a number of nodes via which the packet may still be routed. Its value is decremented at each routing by a node. When its value becomes zero, the lifetime of the packet has expired.

The information field 33 P allows it to be determined from which protocol the packet comes.

The information field 34 @src corresponds to the address of the node transmitting the packet.

The information field 35 @dst corresponds to the address of the receiving node of the packet.

These various information fields thus form the header of the packet.

The packet furthermore comprises an information field 36 which contains the payload data of the packet. It comprises for example a control message of the IGMP type when the information field 33 indicates the value of two.

This first packet transits via the node 12 in the transfer plane. The case is considered where the node 12 encounters a congestion in its internal queues for routing the packets destined for the node 14. According to the document RFC 3168, the node 12 positions the information sub-field CE at the value one in the header of the first packet P1 and thus obtains a second packet P2 that it transmits to the node 14.

The second packet P2 is received by the node 14 in a step F1.

In a step F2, the node 14 processes the second packet received P2 in the control plane. Following this processing, a control message must be sent to the node transmitting the first packet, in other words the node 10. The node 14 transfers the control message to the transfer plane for it to be routed.

In the transfer plane, in a step F3, the node 14 obtains the information relating to a congestion from the second packet received P2.

In a step F4, the node 14 forms the header of a third packet P3 destined for the node 10 and copies into it the information relating to the congestion obtained at the step F3. This third packet also comprises the control message to be sent.

Also in this step F4, the node 14 transmits the third packet P3 to the node 10. The third packet P3 is routed via one or more intermediate nodes.

In a step E2, the node 10 receives the third packet P3 and has thus obtained information relating to the congestion of the path starting from itself and going to the node 14.

This information is neither supplied spontaneously nor in association with a packet which was to be routed in the forward direction but only upon triggering by a requesting node.

The method for obtaining information may be incorporated into a more general method, in which the node 10 interrogates successively the various nodes 14, 16 composing the routing path of the packets destined for the node 18. Such a path can be obtained by means of a routing protocol. It may also be obtained by means of a utility program, known as Traceroute, whose operation is detailed later on with reference to one particular embodiment.

The node 10 may then use this information relating to a congestion obtained for the path going to the node 18 in order to permit or not a new session destined for a correspondent connected to the node 18. The node 10 may also use this information relating to a congestion for modulating the data rates of the communications.

The node 10 may insert first packets P1 according to certain rules, for example either regularly in the stream of data, or regularly for a group of communications between itself and a group of destinations, for example the group of clients connected to the same node of the network, such as a multiplexer DSLAM, for “Digital Subscriber Line Access Multiplexer”.

In a first embodiment, the first packet P1 carries a ICMP control message “Echo request”. In this case, during the step F2 for processing the packet received, the node 14 detects that it must send another control message in response to the ICMP control message “Echo Request”, which consists of an ICMP message “Echo Reply”. The third packet P3 carrying the message “Echo Reply” is modified in order to allow the information relating to the congestion such as received to be fed back. The modifications to be applied to the nodes in order to allow the method for obtaining information to be implemented are thus limited.

In a second embodiment, the node 10 implements the utility program ‘Traceroute’ previously mentioned. This program consists in sending packets indicating a longer and longer duration of validity TTL, for “Time-To-Live”. Each node re-transmitting the packet decrements the duration of validity. When the latter becomes zero, the node does not transmit the packet but sends an ICMP control message “Time exceeded” to the node 10. In this second embodiment, during the processing step F2, the node 14 detects that it needs to send a control message in response to the packet received. This consists of an ICMP control message “Time exceeded”. The third packet P3 carrying the ICMP control message “Time Exceeded” is modified in order to allow the information relating to the congestion such as received to be fed back. It is observed that, in this second embodiment, the modifications to be applied to the nodes are also limited.

In a third embodiment, a new message corresponding to a request for supply of the congestion information is provided for a control protocol, for example for the ICMP protocol. The first packet P1, and consequently the second packet P2, then carries this new control message. A response to the supply request is also provided for supplying the information relating to the congestion. The third packet P3 then carries this message in reply to the supply request.

For all of these embodiments, the initiating node 10 triggering the sending of the first packet P1, and thus triggering the sending of the third packet P3, can supervise the safe reception of the latter. In addition, the implementation of the method for obtaining information does not result in any overloading of the communications network, since these exchanges of first and third packets are one-off events.

The third packet P3 thus carries information relating to the congestion of the path from the node 10 to the node 14 which should not be modified by intermediate nodes routing the third packet to the node 10.

In one particular embodiment, the intermediate node or nodes routing the third packet P3 in the backward direction, in other words from the node 14 to the node 10, are therefore made to verify whether, in the transfer plane, the third packet P3 carries a control message belonging to the group comprising an ICMP message “Echo Reply”, an ICMP message “Time exceeded” or else the response to the supply request. If such is the case, the intermediate node does not modify the information field 31 of the third packet P3, even if it encounters a situation of congestion in this backward direction.

In the following, the case of a packet communications network 1 is considered in which the nodes implement a differentiated routing of the packets depending on classes of service, or CoS, which is for example the case of a communications network in Diffserv, for “Differentiated Services”, mode. In such a network, the packets carry information relating to their class of service. By way of example, for four classes of service denoted from 1 to 4, a packet of service class 1 benefits from the highest level of priority; a packet of service class 4 will have the lowest level of priority.

In such a network, a variant is provided for the three embodiments allowing a node to obtain information relating to a congestion for the routing of the packets for a given class of service. Indeed, in such a network, a queue is generally provided for each of the classes of service. One class of service may then be affected if the traffic generated by the packets of this class is greater than the processing capacities of the node.

The first packet P1 transmitted by the node 10 comprises an information field 30 comprising the class of service for which the congestion information is requested. Thus, the node 10 can obtain information relating to the congestion of the given service class for the path going to the node 14.

As an option, an intermediate node can also position the information relating to a congestion for all the classes of service of level higher than the given service class.

One exemplary embodiment of the method for obtaining information in a communications network in Diffsery mode will now be described by way of illustration.

In this example, the node 10 acts as a content server, providing the functions of an audiovisual service platform and incorporating a control device. The control device may also be external to the content server.

The content server 10 is able to deliver packets of data forming a video stream to client terminals, for example the node 16, across the packet communications network 1 via the nodes 12, 14. The client terminal 16 corresponds for example to a residential gateway, forming the point of input to a residential network of a user. The node 12 corresponds to a router and the node 14 corresponds to a unit of equipment for accessing the communications network, for example a multiplexer DSLAM, for “Digital Subscriber Line Access Multiplexer”, to which the client terminal 16 is connected. The node 18 corresponds to a unit of equipment of the residential network, for example a terminal of the PC type.

It goes without saying that the invention is applicable to other contexts than that just described. For example, the terminal of the PC type may be connected directly to the network, without going via a gateway. Similarly, the node 16 may be the point of input to a corporate network. The node 14 may, on the other hand, be of any DSLAM type as already mentioned, or as a variant an MSAN, for “MultiService Access Node”, using an ADSL, for “Asymmetric Digital Subscriber Line”, technology or optical FTTH, for “Fiber To The Home”, technology.

The IP communications network in Diffsery mode simultaneously supports priority services referred to as “Premium” and non-priority referred to as “Best Effort”. As long as the proportion of traffic relating to “Best Effort” services with respect to that relating to “Premium” services remains high in volume, no particular mechanism, other than the mechanisms for prioritization provided by Diffserv, is required. This is because the simple prioritization of the data streams associated with “Premium” services over data streams associated with “Best Effort” streams allows a satisfactory level of quality of service to be ensured for the data streams associated with “Premium” services, by potentially eliminating a part of the data streams associated with the “Best Effort” services when the loading levels become very high.

In contrast, when the proportion of “Premium” services becomes high in volume, it is no longer possible to only count on the Diffsery prioritization mechanisms for saving the data streams associated with “Premium” services. In this case, only admission control functions limiting the establishment of new communications of the “Premium” type and using congested resources, or else adapting the data rate of the communications of the “Premium” type, for example by means of SVC, allow a satisfactory level of quality to be ensured for the communications of the “Premium” type already established.

The implementation of the method for obtaining information allows the implementation of these functions to be triggered.

At the step E1, the content server 10 inserts ICMP “Echo Request” messages for the “Premium” services destined for the nodes 14, 16 forming the route toward the final client.

Upon receipt (step F1) of a first packet P1 carrying the ICMP “Echo Request” message, the receiving node indicates (step F4), in a third packet P2 carrying an ICMP “Echo Reply” message, any potential congestion affecting the forward direction of the “Premium” services, in other words from the content server 10 toward the final client. This could for example be the exceeding of a threshold level in a queue.

Upon receipt of this explicit notification, the content server 10 then implements the control function for admission of new communications for “Premium” services and using the congested resource. The freeing up of the content server 10 happens after a certain period without receiving congestion notifications. The “Best Effort” services are not affected by the implementation of the method for the “Premium” services. Thus, even if a class with low priority, for example for the “Best Effort” services, arrives at saturation, this does not have an impact on the “Echo Reply” messages transmitted for the class with a higher priority level.

The solution proposed is thus particularly well adapted to the systems in which various classes of traffic are defined with a priority for certain classes over the others.

A node unit of equipment of the packet communications network will now be described with reference to FIG. 4. Such a node unit of equipment notably comprises:

a transmitting and receiving module 102, configured for sending and receiving packets in the transfer plane;

a packet processing module 104, configured for processing the packets to be routed;

a control module 106, configured for exchanging control information with another node unit of equipment in the control plane;

a module 108 for detection of a congestion, configured for detecting a congestion likely to degrade routing via this node unit of equipment of packets emitted by the other node unit of equipment.

The control module 106 is furthermore configured for:

receiving a first packet P1 via the module 102 originating from the other node unit of equipment,

processing the first packet P1 and, depending on the latter, request from the module 102 that a control message be sent to the other node unit of equipment.

The module 102 is also configured for processing packets in the transfer plane, and notably for obtaining, from the first packet P1 to which the control message is replying, information relating to a congestion on the path in the forward direction, copying this information into a second packet to be sent. This second packet carries the control message transmitted by the control module 106.

In one embodiment, the control module 106 is also configured for triggering the sending of the first packet P1 to any one of the nodes of the communications network 1.

As previously described, the first packet P1 may comprise a control message ICMP as described in relation to the first and third embodiments.

The first packet P1 may also be a packet for which the duration of validity expires, as described in relation to the second embodiment. In this case, when processing the packet, the packet processing module 104 detects that the lifetime has expired and then transmits this information to the control module 106.

In one particular embodiment, the processing module 104 is also configured so as not to modify the headers of the second packets, when the latter carry a particular control message, such as previously described.

The control module 106 for the node unit of equipment is configured for implementing those of the steps of the method for obtaining information previously described that are executed by the node unit of equipment. These preferably take the form of software modules comprising software code instructions for executing those of the steps of the method for obtaining information previously described that are implemented by a node unit of equipment. The invention therefore also relates to:

a program for a node unit of equipment, comprising program instructions designed to control the execution of those of the steps of the method for obtaining information previously described which are executed by said node unit of equipment, when said program is executed by a processor of the latter;

a recording medium readable by a node unit of equipment on which the program for a node unit of equipment is recorded.

The software modules may be stored in or transmitted by a data storage and/or transfer medium. This medium may be a hardware storage medium, for example a CD-ROM, a magnetic floppy or hard disk, or else a transmission medium such as an electrical, optical or radio signal, or a telecommunications network.

The invention also relates to a communications system in a packet communications network, in which first and second nodes exchange control information within a control plane. The system comprises:

a first node, comprising a control module 106 configured for sending a first packet to a second node, for which the second node needs to send a control message in reply;

a second node such as previously described.

The preceding examples are only possible embodiments of the invention to which it is not limited. Notably, other networks may be involved, such as networks of the ATM type.

1. A method for obtaining, by a first node, information relating to a congestion on a path allowing the routing of packets from said first node destined for a second node in a packet communications network, said congestion potentially degrading said routing, said method for obtaining information comprising the following steps implemented by the second node:
a step for receiving a first packet originating from the first node and destined for the second node, routed via at least a third node, said first packet being provided for triggering the sending of a control message in a control plane in which the first and second nodes exchange control messages;
a step for processing said first packet in the control plane, following which transmission of the control message destined for the first node is requested;
a step for obtaining said information from the first packet received; and
a step for sending a second packet to the first node, said second packet carrying said control message and comprising said information obtained.

2. The method for obtaining information as claimed in claim 1, wherein the first and second nodes implementing a differentiated routing of the packets depending on classes of service, the first packet received comprises information relating to a given class of service and said information obtained relates to a congestion affecting at least said class of service.

3. The method for obtaining information as claimed in claim 1, wherein the control message sent corresponds to a reply message to another control message received in the first packet.

4. The method for obtaining information as claimed in claim 3, wherein said other control message is an echo request transmitted from the first node to the second node.

5. The method for obtaining information as claimed in claim 1, wherein the header of the first packet indicates that a lifetime of said first packet has expired.

6. The method for obtaining information as claimed in claim 1, wherein the second packet being transmitted to the first node via at least a fourth node, said fourth node does not modify the header of the second packet.

7. A node in a packet communications network, configured for exchanging control information with another node within a control plane, comprising:
reception means, configured for receiving a first packet originating from the other node, said first packet being provided for triggering the sending of a control message in the control plane;
means for processing said first packet in the control plane, configured for requesting the transmission of the control message destined for the other node following the processing of the first packet;
means for obtaining information from the first packet relating to a congestion on a path allowing the routing of packets from the other node and destined for said node; and
transmission means, configured for sending a second packet to said other node, said second packet carrying said control message and comprising said information obtained.

8. A communications system in a packet communications network, wherein first and second nodes exchange control information within a control plane, said system comprising:
said first node, comprising transmission means configured for sending a first packet, said first packet being provided for triggering the sending by the second node of a control message in reply, within the control plane;
said second node being configured as claimed in claim 7.

9. A non-transitory computer program product comprising instructions for the implementation of the method for obtaining information as claimed in claim 1, implemented by a node of a packet communications network, when this program is executed by a processor.
